(19) United States
(12) Patent Application Publication
(10) Pub. No.: US 2023/0249795 A1
(43) Pub. Date: Aug. 10, 2023

(54) INTEGRATED ELECTRIC PONTOON DRIVE SYSTEM

(71) Applicant: Hercules Electric Mobility, Inc., Novi, MI (US)

(72) Inventor: James Edward Breyer, Livonia, MI (US)

(73) Assignee: Hercules Electric Mobility, Inc., Novi, MI (US)

(21) Appl. No.: 18/107,281

(22) Filed: Feb. 8, 2023

Related U.S. Application Data
(60) Provisional application No. 63/307,741, filed on Feb. 8, 2022.

(51) Int. Cl. B63H 21/17; B63B 35/38; B60L 50/60; B60L 58/26; B63H 21/38; B63B 11/00; B63H 21/30; B63H 23/34; H01M 10/46; H01M 10/625; H02K 5/10; H02K 9/19; H02K 11/00; H02J 7/00

(52) U.S. Cl. CPC B63H 21/17; B60L 50/60; B60L 58/26; B63B 11/00; B63B 35/38; B63H 21/30; B63H 21/383; B63H 23/34; H01M 10/46; H01M 10/625; H02J 7/0042; H02K 5/10; H02K 9/19; H02K 11/0094; H01M 2220/20

(57) ABSTRACT

An integrated electric pontoon driver system. The drive system may include an electric propulsion system integrated within a pontoon. The electric propulsion system may include an energy storage module configured for storing and supplying electrical power, an onboard charging module configured for managing charging and discharging of the electrical power to and from the energy storage module, and an electric drive module configured for converting the electrical power discharged from the energy storage module to mechanical power operable for propelling the marine vessel through a body of water.

### INTRODUCTION

The present disclosure relates to electrically powered propulsion systems, such as but not necessarily limited to propulsion systems relying on an electric motor to power a propeller, an impeller, or other motive element in a manner sufficient for generating mechanical thrust operable for propelling a marine vessel through a body of water.

Marine vessels have historically been powered with internal combustion engines configured to consume fossil fuels, with the engines correspondingly expelling exhaust gases and other harmful byproducts to the environment. The replacement of such internal combustion engines with electric motors and other more environmentally friendly devices may be beneficial in ameliorating environmental impacts. The fuel-based engines produce power and torque, which is directly related to an amount of fuel consumed and noise that also increases as a result of increasing power and speed. The exhaust gasses expelled from the gas engine contains harmful and toxic materials, as well as odiferous content which is generally offensive to humans and animals. The toxic exhaust contains carbon dioxide, carbon monoxide, and other greenhouse gasses, along with water vapor, where molecules with unburned oil and gasoline may be attached to the water vapor, thusly directly contaminating surrounding water, plant, and wildlife directly. Gasoline and diesel engines typically create power directly proportional to its volumetric displacement, which tends to require more mass and complexity.

### SUMMARY

One non-limiting aspect of the present disclosure relates to an electric propulsion system that produces significantly less sound pressure, resulting in lower acoustic sound volume and tone, where it may be almost imperceivable at short distance. The electric propulsion system may operate without producing these contaminants associated with fuel-based engines, thusly improving the environmental experience of the operators and owners as well as other users of this local environment. The electric propulsion system may occupy significantly less volume and mass than its fueled counterparts, enabling more options for mounting locations and creating an ultra-compact motive drive.

One non-limiting aspect of the present disclosure relates to an integrated electric pontoon drive system. The system may include a pontoon configured to provide buoyancy operable for assisting in floating a marine vessel upon a body of water, optionally with the pontoon including an elongated frame with an interior compartment. The system may further include an electric propulsion system integrated within the interior compartment. The electric propulsion system may include an energy storage module configured for storing and supplying electrical power, an onboard charging module configured for managing charging and discharging of the electrical power to and from the energy storage module, and an electric drive module configured for converting the electrical power discharged from the energy storage module to mechanical power operable for propelling the marine vessel through the body of water.

The electric drive module may include an electric motor configured to convert the electrical power to mechanical power.

The system may include an outdrive including a propeller operably coupled to a driveshaft, the driveshaft configured to be rotated by the electric motor, the propeller rotating with the driveshaft to provide thrust operable for propelling the marine vessel through the body of water.

The electric drive module may be disposed within a watertight compartment, optionally with the watertight compartment including a removable maintenance hatch configured for accessing the electric motor.

An outboard end of the watertight compartment may include a mounting flange configured to seal or close off the watertight compartment and to at least partially define a transom of the pontoon.

The mounting flange may include an aperture therethrough for, the driveshaft connecting through the aperture to mechanically couple the motor with the outdrive.

The electric propulsion system may include a coolant system having a coolant tank and a heat exchanger, with the coolant tank configured to exchange fluid with a cooling element of the electric drive module to dissipate heat therefrom and the heat exchanger configured to exchange fluid with a cooling element of the energy storage module to dissipate heat therefrom.

An underside of the coolant tank and an underside of the heat exchanger may be configured to rest against and thermally couple with a bottom surface of the pontoon to dissipate heat from the coolant tank and the heat exchanger via the pontoon to the body of water.

The coolant system may be a closed system such that the fluid exchanged through the coolant tank and the fluid exchanged through the heat exchanger are isolated from the body of water.

The system may include one or more drive module bulkheads configured to support and vertically offset from the bottom surface of the pontoon an underside of the watertight compartment forward of the mounting flange.

The onboard charging module may be disposed above the coolant tank and the heat exchanger, optionally with the coolant system disposed between the electric drive module and the energy storage module.

The energy storage module may include a battery configured for storing and supplying at least a portion of the electrical power used to operate the electric motor.

The pontoon may include a hull, a lid, and a bow end, with the interior compartment corresponding with an interior of the pontoon defined by the hull, lid, bow end, and mounting flange.

The electric motor, the onboard charging module, the coolant tank, the heat exchanger, and the battery may be entirely enclosed within the interior compartment.

The watertight compartment may be formed by four sidewalls sealing with an endwall and the mounting flange, optionally with the four sidewalls and/or the endwall including one or more fasteners configured for attachment to the pontoon.

The electric motor may be configured to provide at least 200 horsepower (hp).

One non-limiting aspect of the present disclosure relates to an integrated electric pontoon drive system. The system may include a pontoon configured to provide buoyancy operable for assisting in floating a marine vessel upon a body of water and an electric propulsion system integrated with the pontoon. The electric propulsion system may include a battery configured for storing and supplying electrical power, an onboard charging module configured for managing charging and discharging of the battery, an outdrive including a propeller operably coupled to a driveshaft, optionally with the driveshaft configured to rotate the propeller to provide thrust operable for propelling the marine vessel through the body of water, an electric motor configured for converting the electrical power discharged from the battery to mechanical power operable for rotating the driveshaft, and a coolant system configured for cooling the electric motor and the battery.

The battery, the onboard charging module, the electric motor, and the coolant system may be sealed within an interior compartment of the pontoon.

The electric motor may be configured to provide at least 200 horsepower (hp).

One non-limiting aspect of the present disclosure relates to a marine vessel. The vessel may include a deckhouse configured for carrying passengers, an electric propulsion system, a coolant system configured for cooling the electric motor and the battery, and a plurality of pontoons attached to an underside of the deckhouse, optionally with the pontoons configured to provide buoyancy operable for floating the deckhouse upon the body of water. The electric propulsion system may include a battery configured for storing and supplying electrical power, an onboard charging module configured for managing charging and discharging of the battery, an outdrive operable for providing thrust to propel the marine vessel through a body of water, and an electric motor configured for converting the electrical power discharged from the battery to at least 200 horsepower (hp) of mechanical power operable for powering the outdrive. The electric propulsion system may be integrated with one of the pontoons such that the outdrive extends aft of the pontoon. The battery, the onboard charging module, the electric motor, and the coolant system may be enclosed within an interior compartment of the pontoon.

The above features and advantages along with other features and advantages of the present teachings are readily apparent from the following detailed description of the modes for carrying out the present teachings when taken in connection with the accompanying drawings. It should be understood that even though the following Figures and embodiments may be separately described, single features thereof may be combined to additional embodiments.

### BRIEF DESCRIPTION OF THE DRAWINGS

The accompanying drawings, which are incorporated into and constitute a part of this specification, illustrate implementations of the disclosure and together with the description, serve to explain the principles of the disclosure.

FIG. 1 illustrates an assembly view of a marine vessel having an electric propulsion system in accordance with one non-limiting aspect of the present disclosure.

FIG. 2 illustrates a top view of an electrified pontoon having a lid removed in accordance with one non-limiting aspect of the present disclosure.

FIG. 3 illustrates a cross-sectional view of the electrified pontoon having the lid removed in accordance with one non-limiting aspect of the present disclosure.

FIG. 4 illustrates a perspective view of the drive module attached to the outdrive in accordance with one non-limiting aspect of the present disclosure.

FIG. 5 illustrates a top view of a drive module attached to an outdrive in accordance with one non-limiting aspect of the present disclosure.

FIG. 6 illustrates a side view of the drive module attached to the outdrive in accordance with one non-limiting aspect of the present disclosure.

FIG. 7 illustrates an assembly view of the drive module attached to the outdrive in accordance with one non-limiting aspect of the present disclosure.

FIG. 8 illustrates a cross-sectional view of the drive module attached to the outdrive in accordance with one non-limiting aspect of the present disclosure.

FIG. 9 illustrates a perspective view of the propulsion system without the pontoon in accordance with one non-limiting aspect of the present disclosure.

FIG. 10 illustrates a top view of the propulsion system without the pontoon in accordance with one non-limiting aspect of the present disclosure.

FIG. 11 illustrates a side view of the propulsion system without the pontoon in accordance with one non-limiting aspect of the present disclosure.

FIG. 12 illustrates a perspective view of the propulsion system having an alternative configuration for an energy storage module in accordance with one non-limiting aspect of the present disclosure.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

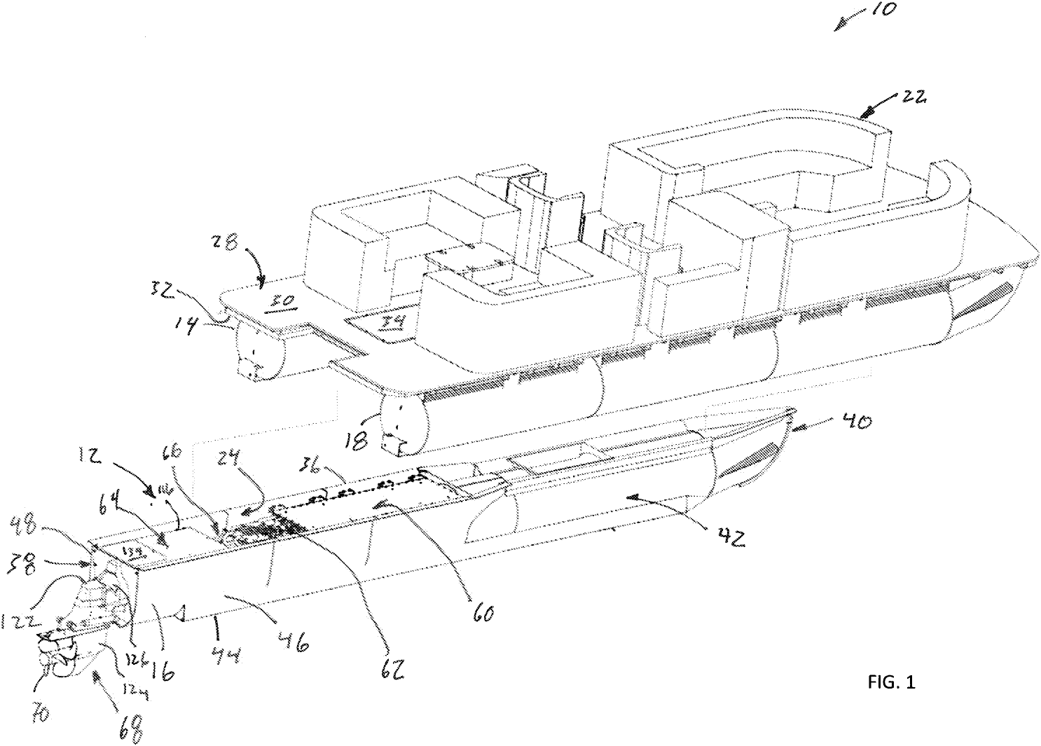

FIG. 1 illustrates an assembly view of a marine vessel 10 having an electric propulsion system 12 in accordance with one non-limiting aspect of the present disclosure. The vessel 10 is shown for non-limiting purposes as a pontoon boat having a plurality of pontoons 14, 16, 18 configured to provide buoyancy operable for assisting in floating a deckhouse 22 or other structure upon a body of water. The propulsion system 12 is shown to be integrated within an interior compartment 24 of an electrically driven one of the pontoons 14, 16, 18 to demonstrate advantageous capabilities of the present disclosure to integrate the electric propulsion system 12 within a typically used portion of the vessel 10. The vessel 10 is illustrated as tri-toon with the electric propulsion system 12 being integrated with a center pontoon 16 of three pontoons for non-limiting purposes as the present disclosure fully contemplates the vessel 10 including more or less pontoons, such as a pair of pontoons with one of the pair having the propulsion system 12. The propulsion system 12 also is presented for non-limiting purposes as being integrated into a single one of the pontoons 14, 16, 18 as the present disclosure fully contemplates multiple pontoons 14, 16, 18 having a propulsion system 12.

While the present disclosure fully contemplates the electronic propulsion system 12 being integrated with pontoons of vessels used for other purposes, such as with pontoons configured to support cargo transport, perform autonomous functions, or float other objects, the illustrated configuration is believed to be particularly beneficial in pleasure or leisure boating activities. One skilled in the art, however, would readily recognize the advantageous capabilities of the propulsion system 12 described herein being integrated into other elements besides pontoons 14, 16, 18, such a boat hulls, jet ski bodies, etc. and/or for other purposes, such as but not necessary limited to being integrated into submersibles to propel a vessel 10 below a water surface and/or in non-marine environments, such as to facilitate moving automobiles, motorcycles, bicycles, aircraft, and other types of vehicles over other terrain.

In the predominately described pleasure or leisure boating environment, one skilled in the art would readily recognize the illustrated deckhouse 22 being representative of a wide variety of seating arrangements, accessory layouts, and configurations commonly employed to facilitate transporting passengers. The deckhouse 22 may additionally include other systems and structures for controlling the propulsion system 12 and/or otherwise controlling operations of the vessel 10. The deckhouse 22 may be constructed upon a deck 28 or other supporting surface, with the deck 28 in turn retaining the pontoons 14, 16, 18. A topside 30 of the deck 28 is shown to support the deckhouse and an underside 32 is shown to support the pontoons 14, 16, 18. The deck may be configured to include a lid 34 for covering a top portion 36 of the pontoon 16. The lid 34 may be removably attached to the deck 28 and/or the pontoon 16 to facilitate accessing the propulsion system 12 from the topside 30 while the pontoon 16 is attached to the deck 28. The lid 34 may be configured to cover and optionally seal an entirety of the pontoon 16 fore and aft from a transom 38 to a bow 40, with a hull 42 of the pontoon 16, or more specifically a bottom surface 44 and opposed sides 46, 48 thereof, defining the interior compartment 24.

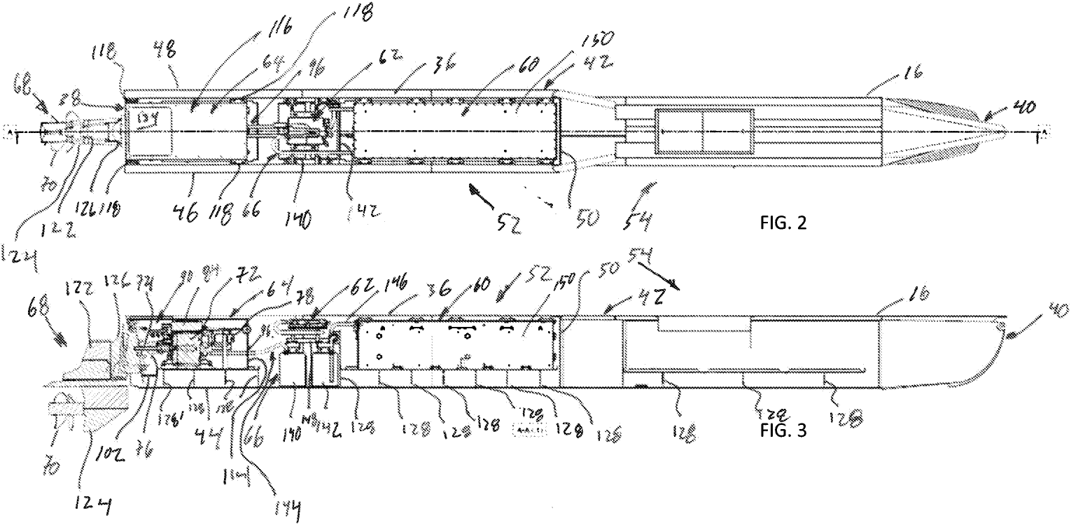

FIG. 2 illustrates a top view of the electrified pontoon 16 having the lid 34 removed in accordance with one non-limiting aspect of the present disclosure. FIG. 3 illustrates a cross-sectional view of the electrified pontoon 16 having the lid 34 removed in accordance with one non-limiting aspect of the present disclosure. The interior compartment 24 may include a bulkhead 50 for separating an aft portion 52 from a forward portion 54. The propulsion system 12 may be integrated within the aft portion 52, with the forward portion 54 being used for ballast, storage, flotation, etc. The bulkhead 50 may extend widthwise across the pontoon 16 and optionally be configured to seal the fore and aft portions 52, 54 or configured with a drainage aperture (not shown) to permit fluids to flow therebetween. The bulkhead 50 may be movable fore and after to adjust a relative size of the corresponding portions 52, 54, such as to facilitate movement of the propulsion system 12 fore and aft for loading distribution. The pontoon 16 is shown to be an elongated frame constructed of metal or other material capable of providing the required flotation buoyancy and the illustrated shape, i.e., the pointed bow 40 and planar transom 38. The present disclosure fully contemplates the pontoons 14, 16, 18 having other configurations, shapes, and constructions, including but not limited to the pontoons 14, 16, 18 being fabricated out of multiple, joined sections and/or different materials, such as plastics.

The propulsion system 12 may include a plurality of components, devices, controllers, systems and the like configured to cooperate in propelling the vessel 10. The propulsion system 12 may include an energy storage module 60, an onboard charging module 62, and an electric drive module 64. The energy storage module 60 may be configured for storing and supplying electrical power. The energy storage system may include multiple positive and negative DC power connectors that may be configured to allow multiple energy storage devices to be connected in parallel or series configurations, which may be beneficial in providing additional energy, optionally compounding current capacity or voltage level. Multiple high-voltage power connections may allow for multiple high-voltage drives or accessory devices to be connected to the energy storage system 60. The onboard charging module 62 may be configured for managing charging and discharging of the electrical power to and from the energy storage module 60. The drive module 64 may be configured for converting the electrical power discharged from the energy storage module 60 to mechanical power operable for propelling the vessel 10 through the body of water. The propulsion system 12 may additionally include a coolant system 66 and an outdrive 68. The coolant system 66 may be configured to dissipate heat from the energy storage module 60 and the drive module 64. The outdrive 68 may be connected to the drive module 64 to generate thrust for propelling the vessel 10 upon the body water, such as in response to thrust generated with a propeller, an impeller, or other device 70 capable of generating a reactive force in response to mechanical power provided from the drive module 64.

Each of the modules 60, 62, 64 and the coolant system 66 may be integrated within the interior compartment 24, or optionally more within the aft portion 52, such that the modules 60, 62, 64 and the coolant system 66 may be entirely enclosed between the lid 34 and the hull 42, optionally with no structural portion thereof extending above the lid 34. Connectors, wiring, cords, tubes, hoses, and other communicative mediums may be included to facilitate exchanging electrical power, electrical and physical control, messaging, information, and the like with each other and/or with other controls included onboard the vessel 10. While not illustrated for the sake of presentation simplicity, multiple wires or other communicative mediums and devices may be included for transferring electrical power between the drive module 64, the onboard charging module 62, and the energy storage module 60, as well as for exchanging controls signals between other unillustrated modules and systems, such as control systems included with the deckhouse 22 or elsewhere onboard or offboard the vessel 10. The wiring and/or other communication infrastructure may be included to provide wired and/or wireless communications networks operable for exchange signaling, messaging, etc. in furtherance of controlling the vessel 10.

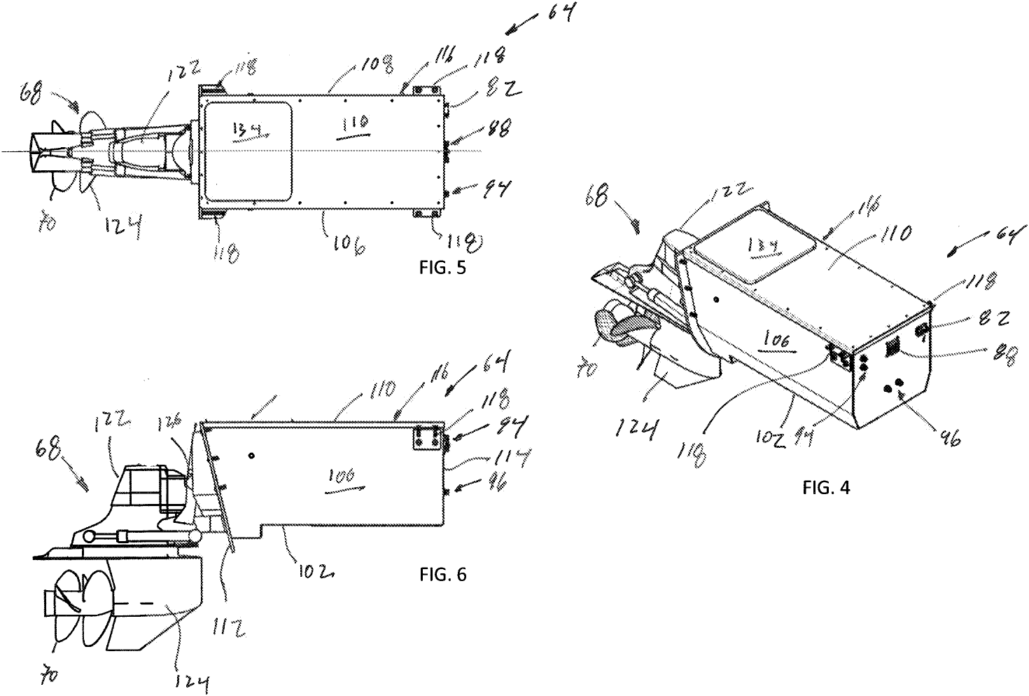

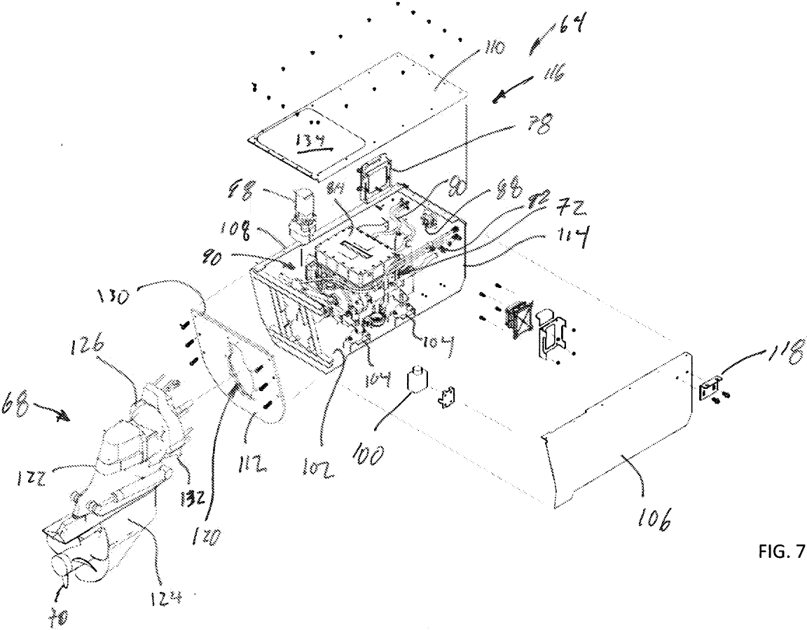

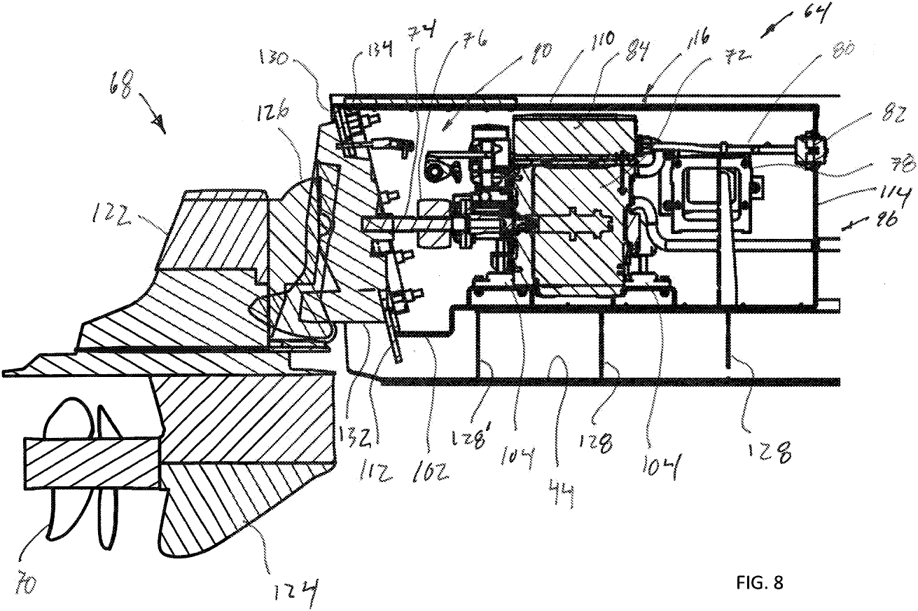

FIG. 4 illustrates a perspective view of the drive module 64 attached to the outdrive 68 in accordance with one non-limiting aspect of the present disclosure. FIG. 5 illustrates a top view of the drive module 64 attached to the outdrive 68 in accordance with one non-limiting aspect of the present disclosure. FIG. 6 illustrates a side view of the drive module 64 attached to the outdrive 68 in accordance with one non-limiting aspect of the present disclosure. FIG. 7 illustrates an assembly view of the drive module 64 attached to the outdrive 68 in accordance with one non-limiting aspect of the present disclosure. FIG. 8 illustrates a cross-sectional view of the drive module 64 attached to the outdrive 68 in accordance with one non-limiting aspect of the present disclosure. The drive module 64 may include an electrically driven machine, such as an electric motor 72, configured to generate mechanical force, or more specifically, to rotate a driveshaft 74 couple via a marine breakaway coupler 76 to actuate the outdrive 68. The motor 72 may be configured to convert AC and/or DC electrical power into the mechanical power used to drive the outboard as well. The motor 72 may also be configured to operate as a generator by converting mechanical power generated with the outdrive 68 to electrical power operable to charge the energy storage module 60.

The electric drive module 64 may include a motor control module, electronic control unit (ECU), vehicle control module (ECM), a multiplex power distribution module (MPDM), a power distribution module (PDM), or other logically functioning device 78 to control the electric motor 72 and/or direct other operations associated therewith. The motor controller 78 may operate in response to instructions exchanged with the onboard charging module 62, a navigation system (not shown) used by a passenger to direct the vessel 10, etc. The motor control module 78 may include a computer-readable storage medium having a plurality of non-transitory instructions stored thereon, which when executed with an associated processor, may be sufficient to facilitate the operations and processes described herein. The motor control module 78 may be configured to receive commands from the passenger operating the marine vessel 10, such as commands used to specify throttle, speed, torque, outdrive 68 leveling, etc., to control operation of the motor 72. The motor control module 78 may correspondingly include algorithms, software, methods, and apparatus of computerized control of electronic systems, which may be utilized with analog communications and serial computer area networks (CAN) control the motor 72 to generate an electro-mechanical force used to rotate the driveshaft 74, and in turn the propellor or impellor, to generate the required thrust to propel the vessel 10 to the desired speed through the body of water.

The motor control module 78 may be part of a computerized control architecture operable with the electric motor 72, optionally utilizing methods and apparatus of computer control along with the software algorithms, to calculate rotational speed of the propeller 70, optionally up to the torque limit of the motor 72, to meet a demand or operational requirement requested by the operating passenger. The control system may change control modes from a speed mode to a torque mode whereby the motor 72 controller may correspondingly calculate the torque to achieve a desired vessel 10 speed up to the speed limit of the electric motor 72 and a gearbox of the outdrive 68 or a transmission of the motor 72. The computer control system may operate utilizing operational parameters, such as those set by the installer or operator of the vessel 10, to limit the upper and lower control limits of a plurality of available calibratable variables, including but not limited to minimum and maximum torque limit, speed limits, revolutions per minute (RPM), operating time, current (I), voltage (V), state of charge (SOC), power (P), etc. The drive module 64 may include additional controllers, such as a computerized control module configured to facilitate networking and/or other communications with the motor control module 78.

The integrated controls of the drive module 64 may be particularly beneficial in enabling an operator to transmit signals thereto, such as to control the direction and/or speed of movement of the outdrive 68. The integrated controls may optionally include capabilities for both wired and wireless control, e.g., to allow an operator to control the motor 72 using signals transmitted through cables or wires from a throttle control/box on deck while also enabling the operator to use remote control when moving around deck away from the throttle control/box. The control methods and apparatus may be utilized to provide computer control of the motor 72 and accessory devices considered to be portions of the propulsion system 12. The controls of the drive module 64 may be configurable via electronic communications and settings configurable by electronic input to vary the output power, speed, and torque of the drive system, up to the limits of output power as specified and programmed to the approved power limitation of the attached vessel 10. Additional limits may be configured by installers and operators to adjust the output power in a range from the upper power limit down to a minimum positive power limit providing positive motive thrust.

The drive module 64 may include cables, such as high voltage cables 80, configured to exchange electrical power with onboard charging module 62 via a watertight high voltage connection 82. In the case of the motor 72 being powered with AC power, the drive module 64 may include an inverter 84 for converting DC power provided from the onboard charging module 62 to AC power used for powering the motor 72. The drive module 64 may include a watertight low voltage connection 88 for electrically connecting to a low power, AC output of the inverter 80. The AC electrical power may be communicated from the inverter 84 through low voltage cables (not shown) via the watertight low voltage connection 88 whereby a circuit, cord, or other conducting medium (not shown) may be used to communicate the AC electrical power to AC loads, devices, etc. included onboard the burning vessel 10, such as to facilitate powering electronic devices included within the deckhouse 22. The drive module 64 may include a power steering system 90 configured for steering the outdrive 68, such as in response to hydraulic pressure generated via power steering supply lines 92 connected via watertight hydraulic power steering connections 94 to corresponding controls in the deckhouse 22. The drive module 64 may include cooling elements configured to interface with the coolant system 66 via heat exchanger connections 96. The drive module 64 may include an outdrive pump 98 and end outdrive oil reservoir 100 to facilitate controlling trim cylinders of the outdrive 68 and delivery of oil needed an operation thereof.

The motor 72 and the devices, controllers, etc. attached thereto, may be mounted to a base sidewall 102 with a plurality of motor mounts 104. The base sidewall 102 may be one of a plurality of sidewalls 102, 106, 108, 110 configured to cooperate with a mounting flange 112 and an endwall 114 to provide a watertight compartment 116 for the drive module 64. Additional fasteners and mounts may be included to facilitate connecting additional internal devices, components, etc. of the drive module 64 to surfaces within the watertight compartment. A plurality of pontoon attachments 118 may be included for mounting the drive module 64 to the pontoon 16. The pontoon attachments 118 are shown to be comprised of removable fasteners, which may be advantageous permitting integration of the drive module 64 with the pontoon 16 in a removable manner. The present disclosure fully contemplates using permanent fastening, such as welds, glues, etc. to similarly integrate the drive module 64 with the pontoon 16. The watertight compartment is shown to be separate from the pontoon 16 in order to demonstrate one advantageous capability of the present disclosure to provide modularity, with the drive module 64 being capable of independent manufacture from the pontoon 16. The present disclosure fully contemplates the drive module 64 being formed as part of or otherwise assembled with the pontoon 16.

The drive module 64 may be assembled with and/or independently of the outdrive 68. The outdrive 68 is shown for exemplary purposes as being fastened to the mounting flange 102 to demonstrate one advantageous capability of the present disclosure to provide modularity, with the outdrive 68 being assembled as part of the drive module 64, such as to provide a singular electrically driven outdrive assembly capable of being integrated with the pontoon 16 or other structure of a marine vessel 10. A plurality of mounting bolts may be utilized to attach the outdrive 68 relative to an aperture 120 in the mounting flange 102 to facilitate mechanically coupling the outdrive 68 to the driveshaft 74. A seal may optionally be included around the aperture 120 to facilitate maintaining integrity of the watertight compartment 116. The outdrive 68 may include an upper unit 122 and a lower unit 124 attached via a gimbal bracket 126 to the mounting flange, with the gimbal bracket raising and lowering the outdrive 68 according to movement of the trim cylinders and turning the outdrive 68 side to side according to the hydraulic steering system. The attachment of the outdrive 68 to the drive module 64, of course, may vary depending on the construction and configuration of the outdrive 68, with the illustrated configuration being correspondingly presented as one of many types of outdrives capable of being easily coupled with the driveshaft 74 and/or the motor 72.

The drive module 64 may be assembled with and/or independently of the outdrive 68. The lower unit 124 may enclose a primary gear drive. The drive unit upper unit 122 may be assembled with and/or without a driveshaft and one or more electric motors. The figures shown indicate the mechanical power transfer through the transom and gimbal for non-limiting purposes as the present disclosure contemplates alternative configurations, including an assembly that includes the electric motor 72 attached to an outdrive drive shaft. In such a configuration, the drive module may include an electric motor/generator which may be electrically coupled in a direct drive configuration or electrically coupled in a parallel hybrid operating mode and/or as a single electric-only outdrive, where HV electrical conductors are routed through the transom and gimbal in a waterproof sealed connection.

As shown in more detail in FIG. 8, a plurality of bulkheads 128 may be configured to extend widthwise across the pontoon 16 to support and vertically offset the base sidewall 102 of the watertight compartment 116 from the bottom surface 44 of the pontoon 16. The mounting flange 102 may be configured in illustrated manner to extend partially below the base sidewall 102 without contacting the bottom surface 44 such that a furthest aft one of the bulkheads 128′ may instead be used to provide a watertight seal or buffer sufficient for sealing the interior compartment 24 forward thereof. The mounting flange 102 may be configured in illustrated manner for non-limiting purposes as the present disclosure fully contemplates the mounting flange 102 having other shapes and sizes, including being shaped and sized to cover an end of the pontoon 16 or otherwise seal the interior compartment 24 forward therefrom. The mounting flange 102, whether configured to seal the interior compartment 24 or in illustrated manner, may define the transom 38. An upper portion 130 of the mounting flange 102 and/or a top sidewall 110 of the watertight compartment 116 may press against, and optionally cooperation with a seal (not shown), to seal off a corresponding upper portion of the interior compartment 24. A bottom support 132 of the gimbal bracket 126 may optionally seal with an aft end of the pontoon 16 to further facilitate sealing of the interior compartment 24.

One or more of the bulkheads 128 may optionally include drain holes to permit water leaking into the pontoon 16 to level out or funnel towards a low spot or other portions of the pontoon 16. The use of the bulkheads 128 to offset the drive module 64 from the bottom surface 44 and any water leakage therein may be beneficial, however, the present disclosure fully contemplates the watertight compartment 116 resting against or being originally manufactured as part of the pontoon 16. The enclosure 116 may be a stand-alone feature capable of being inserted into an existing pontoon 16 and fastened thereto using fasteners, welds, adhesives, etc. The enclosure 116 may also be integrated with the pontoon 16 at the time of manufacture, e.g., the sides and bottom may be defined by the pontoon 16 material and added thereto at the time of manufacture. A removable maintenance hatch 134 may be configured for accessing the electric motor 72 via the enclosure 116, such as to facilitate accessing the internal components of the drive system for maintenance, upgrades, etc.

One non-limiting aspect of the present disclosure contemplates the motor 72 being configured to generate a sufficient amount of horsepower (hp) to propel the marine vessel 10 been there speed mechanical limits associated therewith. The motor 72 may be operable using AC and/or DC electrical power, with the inverter 84 and/or the charge module 62 being corresponding configured. The illustrated configuration may be configured to provide 1-500 hp, 12 hours of use time, top speeds 30-60 mile per hour (mph) speed, 125 kW DC fast charge of the energy storage module 60, and multiple 6.6 kW AC charge modules. These values are merely exemplary of the capabilities of the drive module 64, as integration of the propulsion system 12 within the pontoon 16 in a manner described herein greatly improves the efficiency, thermal management, and operation of and electrically driven drive system such that the motor 72 and other features associated therewith may be present at higher levels. The motor 72 controller and the electronic control system described herein may be additionally beneficial in permitting scalability in the amount of mechanical power and other operational capabilities of the propulsion system 12, including permitting the use of less force generating propulsion systems to facilitate operations where higher performance may be unnecessary. Multiple electric motors may be assembled together to produce more torque and power then a single motor, or can be coupled electrically where one motor is connected to a battery and generator/generator coupled to a fueled engine or fuel-cell, a hybrid electric drive may be utilized for extending the range of the battery capacity indefinitely with a refueling process.

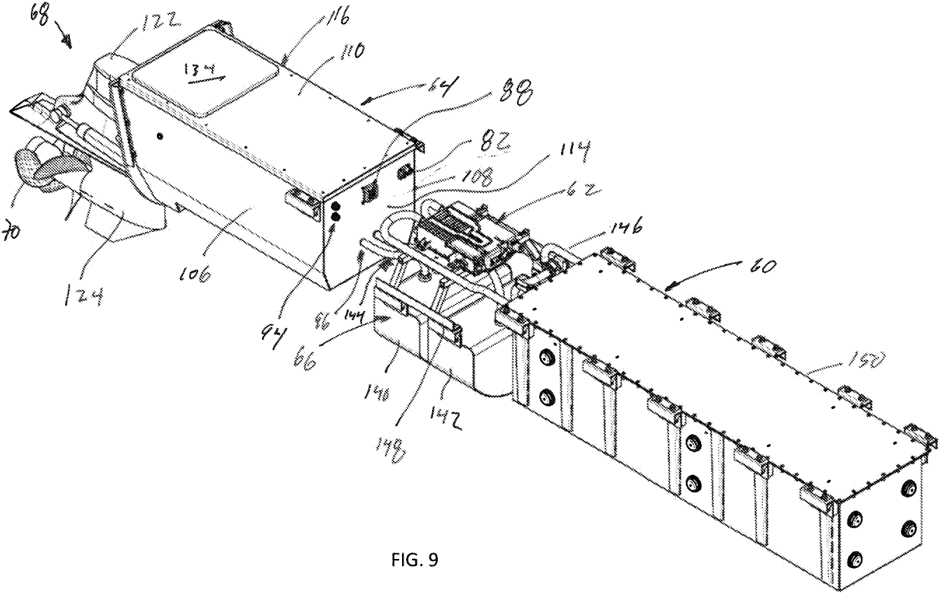

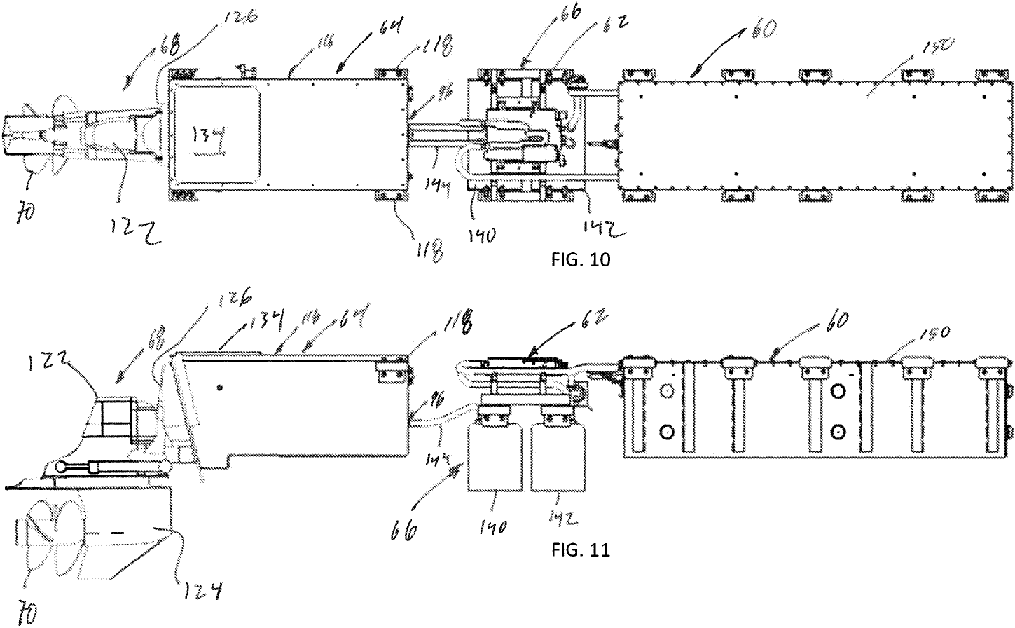

FIG. 9 illustrates a perspective view of the propulsion system 12 without the pontoon 16 in accordance with one non-limiting aspect of the present disclosure. FIG. 10 illustrates a top view of the propulsion system 12 without the pontoon 16 in accordance with one non-limiting aspect of the present disclosure. FIG. 11 illustrates a side view of the propulsion system 12 without the pontoon 16 in accordance with one non-limiting aspect of the present disclosure. The onboard charging module 62 may be disposed above the coolant system 66, with the coolant system 66 and the onboard charging module 62 disposed between the drive module 64 and the energy storage module 60. The present disclosure fully contemplates the modules 60, 62, 64 being arranged differently, however, the illustrated order is believed to be beneficial in separating the heat generated with the drive module 64 and the energy storage module 60 from each other while additionally permitting the relative position thereof fore and aft to be adjusted for loading distribution. As shown in FIG. 3, a plurality of the bulkheads 128 may be configured to support and vertically offset an underside of the energy storage module 60 the bottom surface. The bulkheads 128 may optionally include apertures proximate to the bottom surface to permit fluid to flow therebetween, such as to enable any leakage fluid from the body of water, rain, etc. to spread throughout the pontoon 16 and/or towards a collection area.

The coolant system 66 may include a coolant tank 140 and a heat exchanger 142. The coolant tank 140 may be configured to exchange fluid through tubing 144 with the cooling element of the drive module 64 to dissipate heat therefrom. The heat exchanger 142 may be configured to exchange fluid through tubing 146 with a cooling element of the energy storage module 60 to dissipate heat therefrom. While a singular coolant tank 140 or heat exchanger 142 may be used to collectively dissipate heat from both of the drive module 64 and the energy storage module 60, the separation of the coolant taking the heat exchanger 142 may be beneficial in enabling the use of different cooling fluids and/or separate control methodologies and devices. An underside of the coolant tank 140 and an underside of the heat exchanger 142 may be configured in the illustrated manner to rest against and thermally couple with the bottom surface 44 to dissipate heat therefrom the via the pontoon 16 to the body of water. A thermally conductive material may optionally be disposed between the underside of the cooling tank 140 and the heat exchanger 142 to limit vibration or other forces being received through the pontoon 16.

The cooling fluid or component may be of the reservoir type whereby a cooling fluid, such as glycol or the like, acts as a heat exchanger capable of drawing thermal energy away from the drive module 64 and/or the energy storage module 60. The coolant system 66 may additionally include a radiator (not shown), such as one including a fan, to facilitate cooling the drive module 64 in place of or in addition with the cooling reservoir. The fan/radiator may be useful in cooling when the pontoon 16 is out of the water or under other conditions when enhanced refrigeration may be desired. The cooling component, or pieces or elements thereof, may also be pressed against, laminated with, or otherwise constructed with the pontoon 16 such that the pontoon 16 surface area, particularly when in the water, may be utilized to dispose thermal energy. Such a coolant system 66 may additionally include tubing or other thermal conductors fastened to, welded against, tunneled, or positioned within a pontoon 16 wall/thickness or otherwise integrated therewith.

The coolant system 66 may be a closed system such that the fluid exchanged through the coolant tank 140 and the fluid exchanged through the heat exchanger 142 may be isolated from the body of water. The cooling element included as part of the drive module 64 and the cooling element included as part of the energy storage module 60 may form parts of the closed system such that the coolant fluid is recycled therethrough without relying on the body of water. The capability to facilitate cooling the electric drive module 64 and the energy storage module 60 without relying upon fluid exchanged with the body of water may be beneficial in enhancing environmental protections and otherwise avoiding transferring fluid from the body of water to components or other features of the electric drive and energy storage modules 60, 64. The capability to dissipate heat through the pontoon 16 to the body of water may be additionally advantageous in enhancing environmental protection as it may enable less coolant fluid to be used due to the highly efficient capabilities of the body of water to dissipate heat. In the event the pontoon 16 leaks, the cooling tank 140 and the heat exchanger 142 may be sufficiently sealed to prevent the cooling fluid therein from engaging with the leakage fluid, optionally with any such leakage fluid interacting with lower portions of the coolant tank 140 and the heat exchanger 142 to thermally couple a larger portion of the pontoon 16 therewith.

The onboard charging module 62 may be attached by brackets or other supporting structures 148 to be offset from the coolant tank 140 and the heat exchanger 142. This offset may be beneficial separating downward charging module 62 from any fluid leaking into the pontoon 16 while also positioning downward charging module 62 in an area easily accessible through the lid. The lid 34, for example, be removed to facilitate checking connections, re-programming, and performing other maintenance on the onboard charging module 62 without having to disrupt the coolant system 66 and without having to move or otherwise unfasten the electric drive for energy storage modules 60, 64. While not shown for the sake of presentation simplicity, a high-powered bus may be configured through connections between the onboard charging module 62 and the electric drive and energy storage modules 60, 64, with the onboard charging module 62 including a DC-to-DC converter or other suitable circuitry for controlling the exchange of electrical power therebetween. The onboard charging module 62 may be configured to control the discharge of electrical power from the energy storage module 60 to the electric drive module 64 or other systems onboard the vessel 10 and to control the charging of electrical power to the energy storage module 60 from the electric drive module 64 or other systems onboard the vessel 10.

The vessel 10 may include a shore power circuit configured for exchanging electrical power between the onboard charging module 62 and a power grid offboard the vessel 10 (not shown), which the onboard charging module 62 may then disperse to the drive module 64, the energy storage module 60, or elsewhere onboard the vessel 10, such as to facilitate DC-DC fast charging of the energy storage module 60. The vessel 10 may additionally include other electric circuits for charging the energy storage module 60 using electrical power generated from other power sources (not shown), such as to facilitate charging energy storage module 60 using wind, solar, or other energy generation systems, such as from chemical reactions or regenerative charging by the motor 72 or other mechanical source (e.g., crank). The energy storage module 60 may include a battery or other capacitive energy device for storing and supplying electrical power in the contemplated manner. The battery may, for example, be a fuel-cell, lithium, lithium-ion, solid-state, aluminum-air, sodium, sodium-ion, lead-acid, or other type. The battery may be comprised of multiple cells, pouches, or other features capable of storing and supplying electrical power.

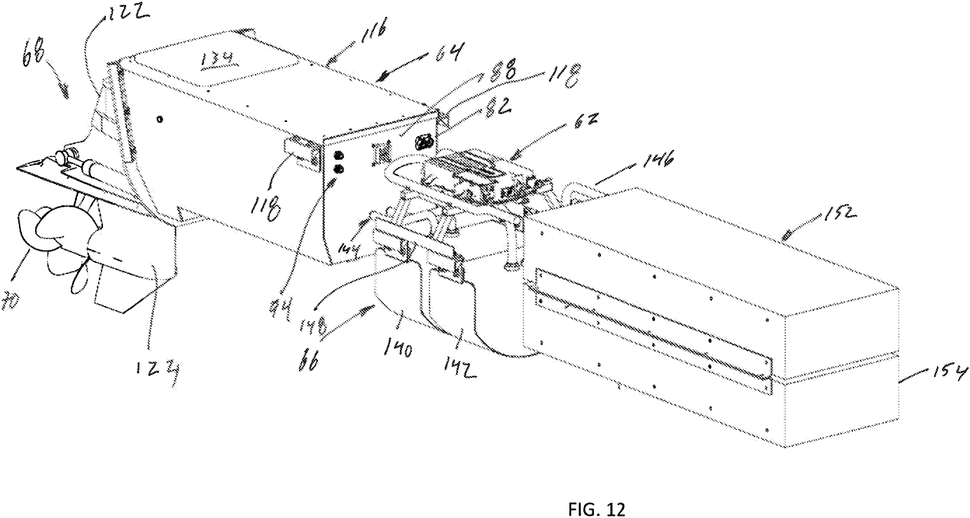

The energy storage module 60, or more specifically the battery, need not necessarily be integrated within the pontoon 16 in the illustrated manner. The battery could, for example, be included within another portion of the vessel 10 and connected to the onboard charging module with a cable or other suitable conductor. One aspect of the present disclosure, for example, contemplates the battery being integrated into the deck structure 28, such as with a low-profile, flat stack of battery cells or the like being integrated into a deck, hull, or other piece of superstructure. Including the energy storage module 60 within the pontoon 16, however, may be preferred in order to provide an integrated, dropping-in drive system capable of and fully integrated within the pontoon 16. The energy storage module 60 shown in FIG. 9 includes the battery or other capacitive energy device within a singular housing 150. FIG. 12 illustrates an alternative configuration for the energy storage module 60 whereby the battery or other capacitive energy device thereof may be segmented into multiple housing 152, 154, optionally with each housing being configured to support a predefined amount electrical power. The desired amount of total electrical power may thereby be determined according to the quantity of housings 152, 154 included as part of each discrete housing, i.e., the quantity of housing may be varied depending on capacity needs.

As supported above, the present disclosure relates to electrically powered propulsion systems, such as but not necessarily limited to propulsion systems relying on an electric motor to power a propeller, an impeller, or other motive element in a manner sufficient for generating mechanical thrust operable for propelling a marine vessel through a body of water. The propulsion system may be incorporated into a pontoon to eliminate the need to package battery or energy storage modules inside the pontoon boat and high voltage wiring in the pontoon boat. Additionally, the pontoon could have a flat bottom allowing the battery module to be heat-sinked to the bottom of the pontoon and eliminate or reduce the need for active battery cooling. The on-board charger and DC-DC conversion can be incorporated into the pontoon minimizing the need for high voltage DC cabling in the pontoon boat. The power distribution unit or fuses/contactors can be contained in the pontoon minimizing any high voltage DC cabling outside the pontoon. The supervisory ECU can be incorporated into the pontoon so that almost all wiring and cabling is contained in the pontoon and is not dispersed through the pontoon boat. The eMotor/inverter and outdrive can be incorporated into the pontoon so that it is a self-contained electronic drive for a pontoon boat. Heat exchanger(s) can be heat-sinked to the pontoon to enable a closed loop cooling for the eDrive/inverter, DC-DC, and onboard charger so the system is sealed and doesn’t need salt or fresh water from the lake inside the pontoon for cooling. A bow thruster, which may run off the inverter, may also be incorporated into the pontoon making the pontoon boat much more maneuverable at low speed. A bilge pump and/or water sensors to determine if water is in the pontoon and to warn the customer. Dry bulkheads could be incorporated between sections of the pontoon to further protect high voltage circuits/components. The propulsion system may be utilized for an outboard, inboard, or stern drive eDrive system. A hydraulicly or electrically actuated wake shaping device may be added to one or both sides of the pontoon for creating wakes for wake surfing. A boat company/marina may power the propulsion system without high voltage expertise. The propulsion system may provide a fully modular approach capable of being installed into a wide variety of pontoon boats. The integration into the pontoon may limit the weight load of the batteries placed on the deck or pontoon boat frame. The propulsion system may be adaptable to standard and DC fast charging on either right or left side of boat, which may optionally operate with a solar canopy or shoreline power.

The terms “comprising”, “including”, and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. “A”, “an”, “the”, “at least one”, and “one or more” are used interchangeably to indicate that at least one of the items is present. A plurality of such items may be present unless the context clearly indicates otherwise. All numerical values of parameters (e.g., of quantities or conditions), unless otherwise indicated expressly or clearly in view of the context, including the appended claims, are to be understood as being modified in all instances by the term “about” whether or not “about” actually appears before the numerical value. A component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

While various embodiments have been described, the description is intended to be exemplary, rather than limiting and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims. Although several modes for carrying out the many aspects of the present teachings have been described in detail, those familiar with the art to which these teachings relate will recognize various alternative aspects for practicing the present teachings that are within the scope of the appended claims. It is intended that all matter contained in the above description or shown in the accompanying drawings shall be interpreted as illustrative and exemplary of the entire range of alternative embodiments that an ordinarily skilled artisan would recognize as implied by, structurally and/or functionally equivalent to, or otherwise rendered obvious based upon the included content, and not as limited solely to those explicitly depicted and/or described embodiments.

What is claimed is:

1. An integrated electric pontoon drive system, comprising:
a pontoon configured to provide buoyancy operable for assisting in floating a marine vessel upon a body of water, the pontoon including an elongated frame with an interior compartment; and
an electric propulsion system integrated within the interior compartment, the electric propulsion system including:
an energy storage module configured for storing and supplying electrical power;
an onboard charging module configured for managing charging and discharging of the electrical power to and from the energy storage module; and
an electric drive module configured for converting the electrical power discharged from the energy storage module to mechanical power operable for propelling the marine vessel through the body of water.

2. The integrated electric pontoon drive system according to claim 1, wherein:
the electric drive module includes an electric motor configured to convert the electrical power to mechanical power.

3. The integrated electric pontoon drive system according to claim 2, further comprising:
an outdrive including a propeller operably coupled to a driveshaft, the driveshaft configured to be rotated by the electric motor, the propeller rotating with the driveshaft to provide thrust operable for propelling the marine vessel through the body of water.

4. The integrated electric pontoon drive system according to claim 3, wherein:
the electric drive module is disposed within a watertight compartment, the watertight compartment including a removable maintenance hatch configured for accessing the electric motor.

5. The integrated electric pontoon drive system according to claim 4, wherein:
an outboard end of the watertight compartment includes a mounting flange configured to seal or close off the watertight compartment and to at least partially define a transom of the pontoon.

6. The integrated electric pontoon drive system according to claim 5, wherein:
the mounting flange includes an aperture therethrough for, the driveshaft connecting through the aperture to mechanically couple the motor with the outdrive.

7. The integrated electric pontoon drive system according to claim 6, wherein:
the electric propulsion system includes a coolant system having a coolant tank and a heat exchanger, the coolant tank configured to exchange fluid with a cooling element of the electric drive module to dissipate heat therefrom, the heat exchanger configured to exchange fluid with a cooling element of the energy storage module to dissipate heat therefrom.

8. The integrated electric pontoon drive system according to claim 7, wherein:
an underside of the coolant tank and an underside of the heat exchanger are configured to rest against and thermally couple with a bottom surface of the pontoon to dissipate heat from the coolant tank and the heat exchanger via the pontoon to the body of water.

9. The integrated electric pontoon drive system according to claim 8, wherein:
the coolant system is a closed system such that the fluid exchanged through the coolant tank and the fluid exchanged through the heat exchanger are isolated from the body of water.

10. The integrated electric pontoon drive system according to claim 9, further comprising:
one or more drive module bulkheads configured to support and vertically offset from the bottom surface of the pontoon an underside of the watertight compartment forward of the mounting flange.

11. The integrated electric pontoon drive system according to claim 10, wherein:
the onboard charging module is disposed above the coolant tank and the heat exchanger; and
the coolant system is disposed between the electric drive module and the energy storage module.

12. The integrated electric pontoon drive system according to claim 11, wherein:
the energy storage module includes a battery configured for storing and supplying at least a portion of the electrical power used to operate the electric motor.

13. The integrated electric pontoon drive system according to claim 12, wherein:
the pontoon includes a hull, a lid, and a bow end, the interior compartment corresponding with an interior of the pontoon defined by the hull, lid, bow end, and mounting flange.

14. The integrated electric pontoon drive system according to claim 13, wherein:
the electric motor, the onboard charging module, the coolant tank, the heat exchanger, and the battery are entirely enclosed within the interior compartment.

15. The integrated electric pontoon drive system according to claim 14, wherein the watertight compartment is formed by four sidewalls sealing with an endwall and the mounting flange, the four sidewalls and/or the endwall including one or more fasteners configured for attachment to the pontoon.

16. The integrated electric pontoon drive system according to claim 14, wherein the electric motor is configured to provide at least 200 horsepower (hp).

17. An integrated electric pontoon drive system, comprising:
a pontoon configured to provide buoyancy operable for assisting in floating a marine vessel upon a body of water; and
an electric propulsion system integrated with the pontoon, the electric propulsion system including:
a battery configured for storing and supplying electrical power;
an onboard charging module configured for managing charging and discharging of the battery;
an outdrive including a propeller operably coupled to a driveshaft, the driveshaft configured to rotate the propeller to provide thrust operable for propelling the marine vessel through the body of water;
an electric motor configured for converting the electrical power discharged from the battery to mechanical power operable for rotating the driveshaft; and
a coolant system configured for cooling the electric motor and the battery.

18. The integrated electric pontoon drive system according to claim 17, wherein the battery, the onboard charging module, the electric motor, and the coolant system are sealed within an interior compartment of the pontoon.

19. The integrated electric pontoon drive system according to claim 18, wherein the electric motor is configured to provide at least 200 horsepower (hp).

20. A marine vessel, comprising:
a deckhouse configured for carrying passengers;
an electric propulsion system including:
a battery configured for storing and supplying electrical power;
an onboard charging module configured for managing charging and discharging of the battery;
an outdrive operable for providing thrust to propel the marine vessel through a body of water;
an electric motor configured for converting the electrical power discharged from the battery to at least 200 horsepower (hp) of mechanical power operable for powering the outdrive; and
a coolant system configured for cooling the electric motor and the battery;
a plurality of pontoons attached to an underside of the deckhouse, the pontoons configured to provide buoyancy operable for floating the deckhouse upon the body of water; and
wherein the electric propulsion system is integrated with one of the pontoons such that the outdrive extends aft of the pontoon and the battery, the onboard charging module, the electric motor, and the coolant system are enclosed within an interior compartment of the pontoon.
